(19) United States
(12) Patent Application Publication
(10) Pub. No.: US 2013/0199697 A1
(43) Pub. Date: Aug. 8, 2013

(54) Device for Adjusting a Layer Front

(71) Applicants: Stéphane Ravat, Clermont-Ferrand Cedex 9 (FR); Thierry Ducros, Clermont-Ferrand Cedex 9 (FR); Mitchel Deboeuf, Clermont-Ferrand Cedex 9 (FR)

(72) Inventors: Stéphane Ravat, Clermont-Ferrand Cedex 9 (FR); Thierry Ducros, Clermont-Ferrand Cedex 9 (FR); Mitchel Deboeuf, Clermont-Ferrand Cedex 9 (FR)

(73) Assignee: Compagnie Generale Des Etablissements Michelin, Clermont-Ferrand (FR)

(21) Appl. No.: 13/699,478

(22) PCT Filed: May 18, 2011
(86) PCT No.: PCT/EP2011/058065

§ 371 Date: Feb. 5, 2013

(30) Foreign Application Priority Data
May 21, 2010 (FR) 1053972

(51) Int. Cl. B29D 30/30

(52) U.S. Cl. CPC B29D 30/30
USPC 156/64; 156/378

(57) ABSTRACT

An improved tire manufacturing technique of laying a reinforcing ply on a receiving surface of generally cylindrical shape, said ply comprising a front edge and a rear edge which are intended to be butted against each other, after a complete rotation of the receiving surface, between a maximum tolerance and a minimum tolerance measured relative to a reference source.

The object of the present invention relates to the field of the manufacture of reinforcing plies intended for tire building.

These reinforcing plies are usually composed of portions of reinforcing thread embedded in rubber, parallel to each other, and lying at a given angle to the longitudinal direction of the reinforcing ply.

The reinforcing plies themselves are usually manufactured from a very wide ply, commonly called an on-grain ply, in which the reinforcing threads are parallel to the longitudinal direction of the ply. For this purpose, portions having a given width are taken from the on-grain ply, with an angle shearing machine, and these portions are assembled together to form a continuous strip in which the threads are orientated relative to the longitudinal direction.

The assembly step consists, in a known way, of positioning reinforcing profiled elements or plies on a receiving surface, having a shape which is generally cylindrical, or sometimes toroidal, in rotation about its axis which is generally positioned horizontally.

The reinforcing plies, which take the form of a continuous strip from which a portion of given length is taken, serve to form the crown reinforcing belt or carcass reinforcing ply. These portions cut to length are also known as plies.

The arrangement is such that the length of the ply is substantially equal to the circumference of the receiving surface, in such a way that, after the ply has been wound in a known way around the receiving surface, the front edge and the rear edge of the ply are positioned end to end and are separated from each other by a minimum distance lying between a maximum tolerance and a minimum tolerance.

However, it has been observed that the geometry of the ply edges is not always rectilinear, and the adjustment of the two edges may be problematic if compensatory action is not taken upstream of the assembly device. These difficulties are due to the nature of the product, which shows a strong tendency to vary its length and/or the angle of the threads under the action of a transverse or longitudinal stress.

Furthermore, the release of the stresses after the cutting of the ply tends to deform the ply edge by curving the threads in a random manner, particularly in the area of the tip.

In order to overcome this difficulty, numerous devices have been proposed by the manufacturers of tire building machines.

For example, U.S. Pat. No. 4,769,104 proposes a method using a set of movable arms for aligning and shaping the edge of a ply previously laid on a magnetic belt. Owing to the necessarily rectilinear shape of the arms, it is not possible to correct curved ply edges. Moreover, the successive action of the arms tends to modify the previously established alignment of the border when the edge is aligned, thus causing an offset at the point where the two ends of the ply are brought together after the ply has been laid on the former.

EP 0 649 730 discloses a method in which the shape of the ply is analysed by cameras. By comparison with a predetermined theoretical shape, an automatic system determines the transverse movements to be made when the piece is moved from an unwinding belt and laid on a magnetic belt. However, the performance of this system has been found to be unsatisfactory for the precise correction of the angular variations of the ply edge relative to a predetermined value.

U.S. Pat. No. 4,857,123 describes a method in which the geometry of the ply edge is evaluated by measurement of the difference between the successive positions of a floating cutter, which is movable in the direction perpendicular to the cutting edge, and a predetermined theoretical cutting line. The angular correction is provided by a manipulator which grips the ply edge and rotates in a controlled manner about an axis perpendicular to the plane of the ply and passing substantially through the centre of the edge, causing the tip and rear end of the ply to undergo an identical angular correction. U.S. Pat. No. 5,092,946 improves the last-mentioned method by proposing the deposition of the ply on a succession of magnetic belts enabling the ply edge to be kept in position at each stage of the laying cycle.

Finally, EP 1 447 210 proposes the measurement of the movement of the front and rear ply edges over detection cells for the purpose of evaluating the geometry of the edges and the ply length between the measurement points. Gripping units are used to grip the ply edge and to correct deformations in the angle of the ply at the moment when the ply is laid on the building drum.

All these devices use relatively complicated means for detecting and correcting the ply edges, and their use is recommended in the case of plies having highly deformed edges.

There is also a known way of adjusting the length of the ply laid on the receiving surface so as to adjust the laid length as a function of the difference between the circumference of the receiving surface and the length of the ply measured between the front edge and the rear edge.

The object of the present invention is to propose an improvement of the measuring and laying device and method mentioned in the preceding paragraph which is relatively simple, and which can prove to be advantageous when the edges of the reinforcing plies are only deformed to a small extent, during the process of cutting the plies and adjusting their length.

The laying method according to the invention is intended for the laying of a reinforcing ply forming the reinforcing belt of a tire on a receiving surface of generally cylindrical shape. Said ply comprises a front edge and a rear edge which are intended to be laid end to end, after a complete rotation of the receiving surface, between a maximum tolerance and a minimum tolerance.

This method comprises steps in which:
a ply of given length is produced,
the length between the front edge and the rear edge is determined on a central measurement line, and on at least two lateral measurement lines positioned transversely, one each side of the central measurement line,
said ply is laid on a starting belt,
the length correction to be made on the central measurement line is determined so as to ensure that the two tips of an edge of the ply corresponding to the measured lengths whose values are most different from each other are placed at equal distances from the reference median line which is located at a distance (Tc) from the reference edge and corresponds to the mean value of the maximum tolerance and the minimum tolerance.
the front edge of the ply is transferred to the receiving surface,
the rest of the ply is laid while the longitudinal movement of the starting belt is adjusted relative to the circumferential movement of the receiving surface in such a way that the length laid on the central line is equal to the length measured on said central measurement line corrected by said length correction.

The device according to the invention comprises
means of producing a reinforcing ply,
a frame supporting a rotary receiving surface of cylindrical shape,
a starting belt positioned between the ply production means and the receiving surface
a central sensor positioned on the central line of the starting belt and at least two lateral sensors positioned laterally, one each side of the central sensor, and adapted to detect the passage of a ply edge,
calculating means adapted to
determine the length between the front edge and the rear edge on measurement lines positioned in line with the sensors,
determine a value of the correction according to the method of the invention,
control the respective movements of the advance of the starting belt and the rotation of the receiving surface, as a function of said value of the correction.

The following description refers to FIGS. 1 to 10, in which:

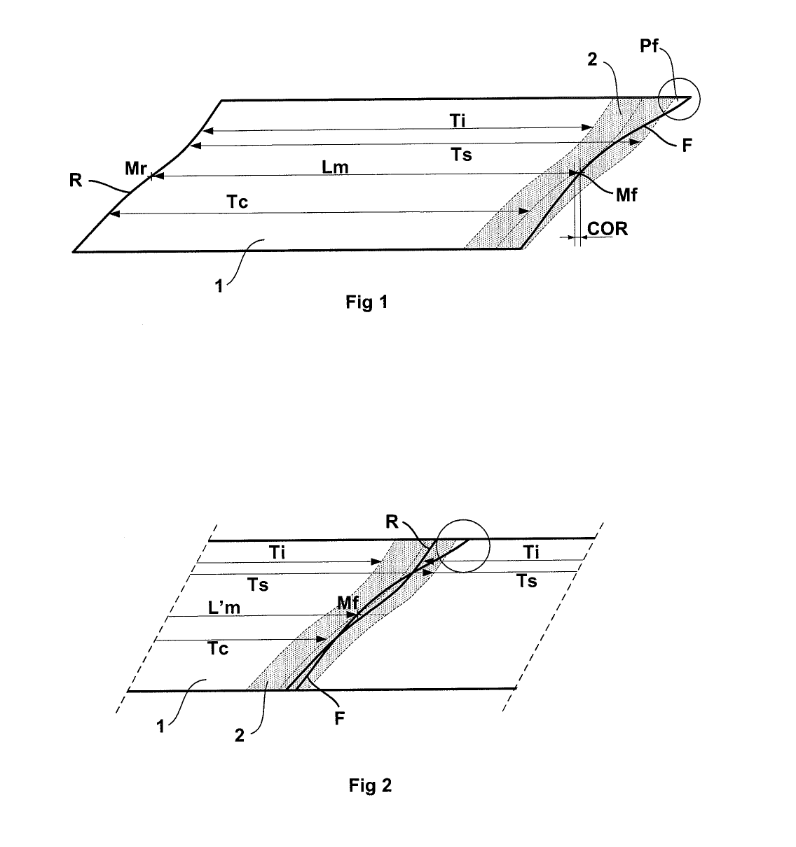

FIGS. 1 and 2 are diagrams of the known method of length correction,

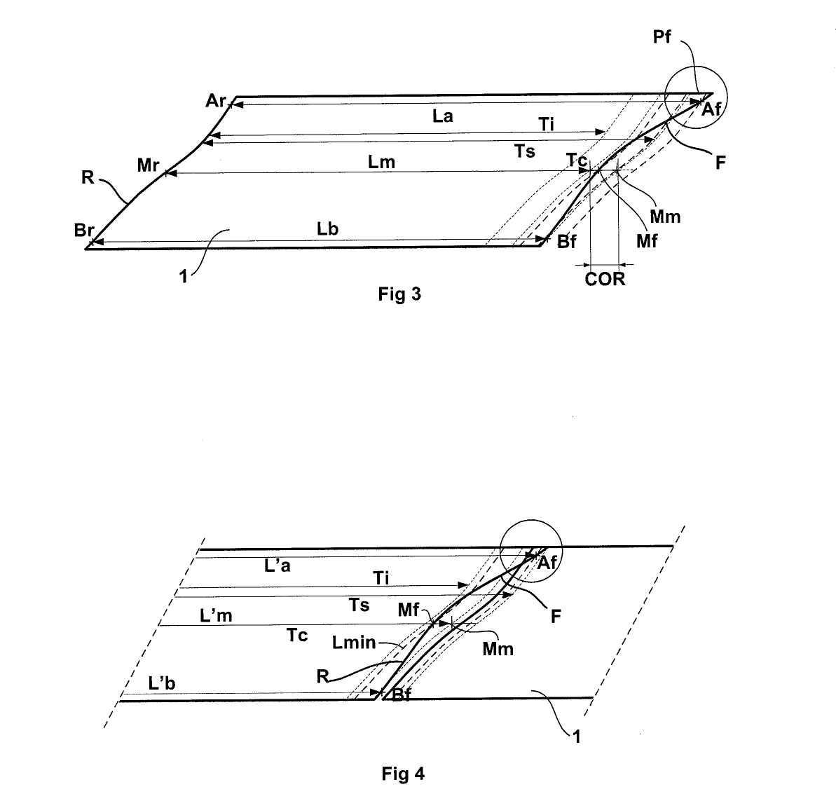

FIGS. 3 and 4 are explanatory diagrams of the method according to the invention,

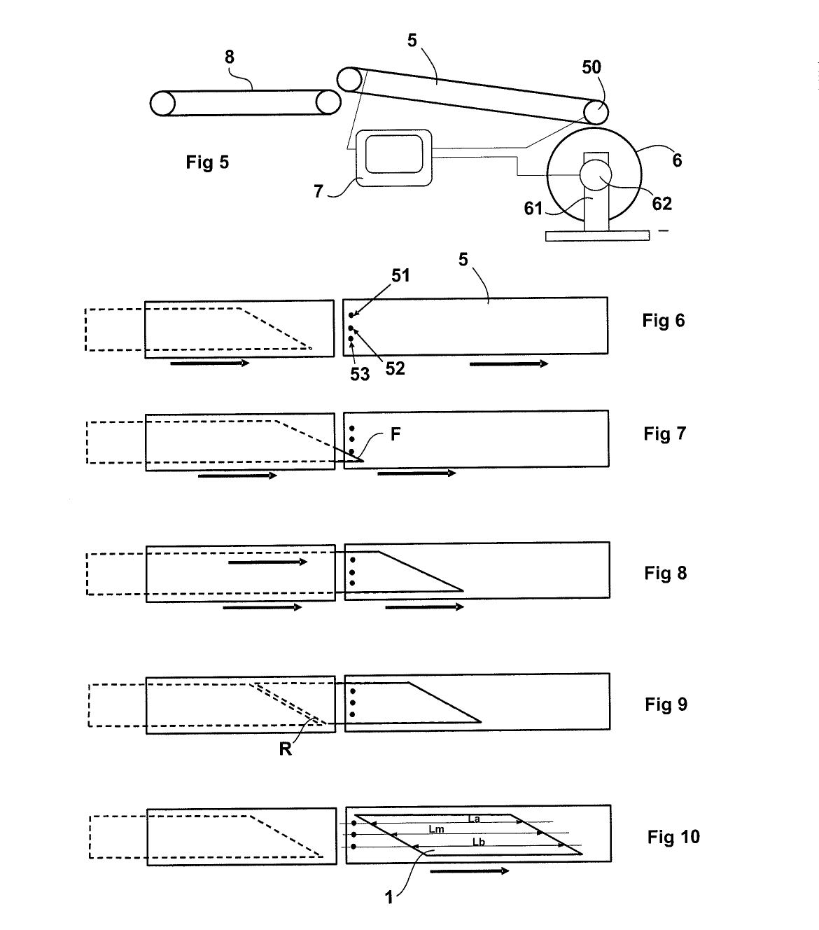

FIG. 5 is a simplified diagram of a device according to the invention,

FIGS. 6 to 10 show the different steps of the laying of a reinforcing ply using a device according to the invention.

FIGS. 1 and 2 show a known configuration in which the length of the ply 1 is measured only in its centre. The length Lm is equal to the distance between the points Mr and Mf which are the intersections of the central longitudinal line with the rear edge R and the front edge F.

The length Lm can be evaluated according to known methods by positioning means for detecting the passage of the ply edge over the central part of the starting belt and for sequentially detecting the passage of the front edge followed by that of the rear edge. These means can comprise a photoelectric cell or alternatively a laser.

During the laying of the ply on a receiving surface of cylindrical shape, the ply is placed on a starting belt. The front edge F is then laid on the receiving surface, after which the ply is wound on until the rear edge is laid.

As mentioned above, it is frequently found that the length Lm differs from the laid circumference, despite the precautions taken to adjust the length of the ply during its production. Consequently the front edge and the rear edge do not butt against each other in a perfect way.

Laying tolerances are therefore defined, resulting in a tolerance region 2 in which the butting is considered to be correct if the front edge and the rear edge are simultaneously contained in this region. The tolerance region 2 is defined by the area enclosed between two homothetic lines of a reference edge, positioned respectively at a distance Ti from said reference edge, where Ti is equal to the lower tolerance, and at a distance Ts from the reference edge, where Ts is equal to the higher tolerance. The values of Ts and Ti can also be defined as the value of the laying circumference +/− a lower tolerance ti and a higher tolerance ts.

It should be noted that the reference edge can be either the front edge, as in the following diagrams and explanations, or the front edge.

Thus, in a known manner, the respective movements of the starting belt are adjusted, during the laying of the ply, relative to the rotary movements of the receiving surface, in order to increase the chances that the front and rear edges will both be located in said tolerance region. For this purpose, the ratio between the movement of the starting belt and the rotation of the receiving surface is determined.

In the case shown in FIGS. 1 and 2, the arrangement is such that the tip of the front edge Mf is placed on a median line located between the higher tolerance and the lower tolerance and at a distance Tc from the reference edge. The value of Tc is equal to half the sum of the lower tolerance and the higher tolerance; that is to say, Tc=½ (Ti+Ts).

For this purpose, a value of the correction of the value to be laid in the centre is calculated thus: COR=½ (Ts+Ti)−Lm. The value of this correction can then be used to calculate the ratio between the movement of the belt and the movement of the receiving surface, as shown in FIG. 1.

However, it has been found that this method, which is unquestionably applicable when the geometric shape of the front and rear edges is the same, is subject to drawbacks in some cases when these geometrical shapes differ greatly, as shown in FIGS. 1 and 2. This is because it has been found that the application of the above method does not enable the front tip Pf to be brought into the tolerance region 2, as shown in FIG. 2.

The known prior art edge correction methods could usefully be applied to correct this situation. However, the implementation of these methods on existing machines would require substantial modifications.

The object of the method according to the invention is to propose a simpler solution which enables the plies to be butted together in the tolerance region with a greater probability of success than in the known prior art method described above.

This method is detailed below with reference to FIGS. 3 and 4. In the method according to the invention, it is proposed that the length Lm of the ply in its centre be measured as before, but also on two other measurement lines La and Lb which are located laterally, one each side of the central line. The lateral measurement lines are preferably positioned near the longitudinal borders of the ply, ideally at a distance of between 10 mm and 40 mm from the longitudinal borders of the ply.

The length La is equal to the length between the points Ar and Af located, respectively, on the rear edge R and the front edge F, the length Lm is equal to the length between the points Mr and Mf located, respectively, on the rear edge R and the front edge F, and the length Lb is equal to the length between the points Br and Bf located, respectively, on the rear edge R and the front edge F. In the example shown in FIGS. 3 and 4, the reference edge is the rear edge.

A maximum length Lmax equal to the maximum of the lengths La, Lb and Lm is determined, as is a minimum length Lmin, equal to the smallest of the lengths La, Lb and Lm. In the example to which the present description relates, Lmin is equal to Lm and Lmax is equal to La.

It should be noted that it may appear useful to increase the number of points of measurement of the ply edges so as to acquire a more complete knowledge of the geometry of the ply edges. In practice, it is found that the measurement of these lengths at only three points is generally sufficient, owing to the relatively standard shape of the front and rear edges.

The lines which are homothetic to the reference edge and which pass through the points on the opposite edge corresponding to the points of measurement of the lengths Lmin and Lmax are then determined. In the example referred to in the description of the invention, these lines pass through the points Mf and Af.

The median line between these two lines is then determined, this line being homothetic to the reference edge from which it is separated by the distance ½ (Lmin+Lmax).

The intersection of the central measurement line with this median line between the minimum and maximum values is located at the point Mm, as shown in FIG. 3.

The value of the correction COR to be provided to bring the point Mm on to the median line of the tolerances Tc is then determined, this median line being the line homothetic to the reference edge and located at a distance of ½ (Ts+Ti), as illustrated in FIG. 4 which shows the respective positions of the front edge F and rear edge R after the ply has been laid on the reference surface.

The value of the correction COR to be applied is therefore equal to half the sum of the higher tolerance and the lower tolerance,

$$\frac{Ts + Ti}{2} ,$$

minus half the sum of the higher length and the lower length,

$$\frac{L max + L min}{2} .$$

In the case described above,

$$COR = \frac{Ts + Ti}{2} - \frac{L max + L min}{2} = \frac{Ts + Ti}{2} - \frac{La + Lm}{2} .$$

The ratio of the advance between the starting belt and the circumference of the receiving surface, determined at the centre of the ply, is equal to k=Lm/(Lm+COR).

The lengths laid on the different measurement lines, equal, successively, to L′a, L′m and L′b, are equal to the lengths La, Lm and Lb multiplied by the ratio k.

It will be noted that the value of this correction can be negative or positive. If this value is positive, as in the case of the example given, the ratio between the speed of unwinding of the starting belt and the circumferential speed of the starting surface will be less than 1, and the speed of the starting belt will be greater than the circumferential speed of the receiving surface. This situation may lead to difficulties in use, as it means that the reinforcing ply will be subjected to compression.

Consequently, arrangements are made to ensure that the value of the correction COR is generally positive in statistical terms, and a reinforcing ply is produced with a theoretical length slightly smaller than the circumference of the receiving surface, in such a way that, during laying, the ratio between the speed of unwinding of the starting belt and the circumferential speed of the receiving surface is greater than 1, causing the speed of the starting belt to be lower than the circumferential speed of the receiving surface, and causing the ply to be laid under tension.

Thus, by placing the point Mm on the central value of the laying tolerance, the chances of positioning all the points on the edge opposite the reference edge in the tolerance range are maximized, given that all the points on the ply edges are located between the maximum and minimum values.

It will also be noted that the tip of the ply Pf, which, in the known prior art method described above, lay outside the tolerance range, is brought back inside this range by the application of the method according to the invention.

It is also possible de determine, immediately before laying, the cases for which it becomes impossible to follow this rule, and which correspond to the cases for which the value of the difference between the maximum length and the minimum length is greater than the value of the difference between the maximum tolerance and the minimum tolerance; that is to say, (Lmax−Lmin)>(Ts−Ti). In this example, a warning can be generated to indicate that the system requires the intervention of an operator.

In the example to which the present description refers, the rear edge R is considered to be the reference edge, but it is entirely possible to follow a similar argument, leading to an identical value of the correction, by taking the front edge F as the reference edge.

FIGS. 5, 6 and 10 show a device according to the invention, capable of applying the method according to the invention as described above.

This laying device comprises means of producing a reinforcing ply 8, represented here by a shearing device which can detach portions of ply from a continuous strip formed from juxtaposed threads and lying at an angle to the longitudinal direction of the ply.

The receiving surface 6, of generally cylindrical shape, is supported by a frame 61 carrying a drive means 62 adapted to cause said surface to rotate about its axis.

A starting belt 5 is positioned between the ply production means and the receiving surface. The advance of this belt is controlled by a motor 50. This belt preferably includes means for pressing the reinforcing ply on to the surface of the belt, so as to prevent any slippage of the ply during laying. In a known way, these means can consist of magnetic elements, if the reinforcing ply is formed from metallic reinforcing threads.

The starting belt includes a central sensor 52 positioned on the central line of the starting belt and at least two lateral sensors 51 and 53 positioned laterally, one on each side of the central sensor, and adapted to detect the passage of a ply edge across each of said sensors. These sensors, located at the entry of the starting belt, detect the passage of the ply edge when the ply is brought from the ply production means on to the starting belt.

Finally, the device includes calculating means adapted to:
determine the length between the front edge and the rear edge on measurement lines positioned in line with the sensors,
determine a value of the correction COR by the method described above,
control the respective movements of the advance of the starting belt and the rotation of the receiving surface, as a function of said value of the correction, by acting on the motors 50 and 62.

FIGS. 6 to 10 show the stages of the sequence of determination of the lengths La, Lm and Lb, with the successive detection of the passage of the front edge F and the rear edge R over the line of sensors 51, 52, 53 located at the entry of the starting belt.

1. A method of laying a reinforcing ply on a receiving surface of generally cylindrical shape, said ply comprising a front edge and a rear edge which are intended to be butted against each other, after a complete rotation of the receiving surface, between a maximum tolerance (Ts) and a minimum tolerance (Ti) measured relative to a reference source, comprising the steps of:
producing a ply having a given theoretical length;
determining the length between the front edge and the rear edge on a central measurement line, and on at least two lateral measurement lines positioned transversely one on each side of the central measurement line;
laying said ply on a starting belt;
determining the length correction to be made on the central measurement line so as to ensure that the two tips of an edge of the ply corresponding to the measured lengths whose values are most different from each other (Lmax, Lmin) are placed at equal distances from the reference median line which is located at a distance from the reference edge and which corresponds to the mean value of the maximum tolerance and the minimum tolerance;
transferring the front edge of the ply to the receiving surface; and
laying the rest of the ply while the longitudinal movement of the starting belt is adjusted relative to the circumferential movement of the receiving surface in such a way that the length laid on the central line is equal to the length measured on said central measurement line corrected by said length correction.

2. The method according to claim 1, wherein the value of the correction to be applied is equal to half the sum of the higher tolerance and the lower tolerance
$$( \frac{Ts + Ti}{2} ) ,$$
minus half the sum of the higher length and the lower length
$$( \frac{L max + L min}{2} ) .$$

3. The method according to claim 1, wherein the front edge is chosen as the reference edge.

4. The method according to claim 1, wherein the rear edge is chosen as the reference edge.

5. The method according to claim 1, wherein the length, on the central measurement line, of the ply which is produced is, on average, smaller by a given amount than the circumference of the laying surface, in such a way that the value of the correction is generally positive.

6. The method according to claim 1, wherein an alarm is generated if the difference between the maximum length and the minimum length is greater than the difference between the maximum tolerance and the minimum tolerance ((Lm−Li)>(Ts−Ti)).

7. A device for laying a reinforcing ply on a receiving surface of generally cylindrical shape, comprising:
means of producing a reinforcing ply;
a frame supporting a rotary receiving surface of cylindrical shape;
a starting belt positioned between the ply production means and the receiving surface;
a central sensor positioned on the central line of the starting belt and at least two lateral sensors positioned laterally, one on each side of the central sensor, and adapted to detect the passage of a ply edge across each of said sensors; and
calculating means adapted to:
determine the length between the front edge and the rear edge on measurement lines positioned in line with the sensors,
determine a value of the correction according to claim 1, and
control the respective movements of the advance of the starting belt and the rotation of the receiving surface, as a function of said value of the correction.

8. The device according to claim 7, wherein the lateral sensors are positioned at a distance of between 10 mm and 40 mm from the longitudinal borders of the ply.
